(19) United States
(12) Patent Application Publication
(10) Pub. No.: US 2024/0139873 A1
(43) Pub. Date: May 2, 2024

(54) WELDING OF METALLIC FOILS BY MEANS OF A LASER

(71) Applicant: Manz AG, Reutlingen (DE)

(72) Inventors: Vasile Raul MOLDOVAN, Stuttgart (DE); Denny SOERYANTO, Neckartenzlingen (DE); Dmitrij WALTER, Altdorf (DE); Markus HOFMANN, Stuttgart (DE)

(73) Assignee: Manz AG, Reutlingen (DE)

(21) Appl. No.: 17/975,859

(22) Filed: Oct. 28, 2022

(51) Int. Cl. B23K 26/21; B23K 26/32

(52) U.S. Cl. CPC B23K 26/21; B23K 26/32

(57) ABSTRACT

A method for welding metallic foils includes the method steps of: forming a parallel joint with a plurality of metallic foils to be joined, by arranging the foils in such a way that they contact each other over a wide area, and welding the metallic foils together by directing a laser beam onto an end face of the parallel joint of the foils, such that a welded seam joining the foils is formed.

### BACKGROUND OF THE INVENTION

### 1. Field of the Invention

The invention relates to a method for welding metallic foils, having the method steps of:
a. forming a parallel joint with a plurality of metallic foils to be joined, by arranging the foils in such a way that they contact each other over a wide area,
b. welding the metallic foils.

### 2. Description of the Related Art

In the production chain for Li-ion batteries, a stack consisting of a plurality of thin metallic foils must be connected to a central current collector. Depending on the cell design and the energy density, ten or more electrode foils, i.e., cathode foils or anode foils, with a thickness of around 10 μm, must be welded to a collector.

Efforts are being made to increase the number of electrodes within a battery, in order to increase the performance of accumulators/batteries. This also increases the number of electrode foils which must be welded. There exists a general need to provide energy storage devices with increased energy density and storage capacity. Battery cells are usually manufactured by stacking anode sheets, cathode sheets, and separators arranged between them, and then welding the current conductors assigned respectively to the anode sheets and cathode sheets.

On the one hand, the use of resistance welding is known. The disadvantage of resistance welding is that only workpieces having a relatively small volume can be welded together. As such, there is a limit to the number of layers that can be stacked.

Furthermore, the practice of connecting the current conductors by ultrasonic welding is known. To do this, it is necessary to press the current conductors together. Ultrasonic welding can produce particles that impair the functionality of the battery cell. In addition, ultrasonic welding is also limited in the number of layers that can be welded together.

Connecting the current conductors by means of laser welding is also known. In this case, it must be ensured that there is no air gap between the current conductors.

When welding using a laser, the foils are arranged with a collector in an overlapping manner. The laser beam is aimed at the broad side of the electrode sheets. Welding is carried out through the electrode sheets to the collector. As the number of electrodes increases, so does the thickness of the stack and thus the thickness of the material through which welding has to be carried out. In order to be able to ensure a bond to a collector, the energy input per unit length must be increased. An increase in the energy input per unit length can be achieved, for example, by increasing the laser power or by reducing the welding speed. A higher energy input per unit length increases the mechanical as well as the thermal stress for the electrode foils, which are very thin compared to the current collector.

To reduce the stress on the electrode foils, the positions of the welded components can be swapped so that the laser beam hits the collector first, and the foils are welded together after the collector has been welded through. Compared to the conventional arrangement, the required energy input per unit length is significantly higher with this arrangement since the welding must be performed through the electrode stack and the entire thickness of the collector.

It is also necessary to keep the process temperature as low as possible, as there are temperature-sensitive components such as the sealing seam, separator, or active material of the electrode sheet near the welding point.

### SUMMARY OF THE INVENTION

It is therefore the object of the present invention to provide a method with which thin metallic foils, in particular electrode foils, can be welded substantially independently of the thickness of the stack formed from the foils, without subjecting the foils to excessive thermal stress.

According to the invention, this object is achieved by a method for welding metallic foils, having the following method steps:
a. forming a parallel joint with a plurality of metallic foils to be joined, by arranging the foils in such a way that they contact each other over a wide area,
b. welding the metallic foils together by directing a laser beam onto an end face of the parallel joint of the foils, such that a weld seam joining the foils is formed.

The foils can have a thickness in the range between 5 and 15 μm, preferably a thickness of about 10 μm.

With the method according to the invention it is possible to weld a large number of foils, in particular electrode foils. In particular, the thickness of the parallel joint is not a limiting factor, as only the end face is welded. In particular, it is not necessary to weld through the entire thickness of the stack from a broad side.

The welded seam depth which must be achieved is no longer dependent on the number of foils. Rather, the welded seam depth which must be achieved is determined by the connection cross section required for safe current conduction. With the method according to the invention, a large connection cross section can be achieved by a less-deep and long welded seam. By reducing the depth of the welded seam, the energy input per unit length required for welding, and thus the energy input into the parallel joint, is significantly lower. The mechanical and thermal stress on the foils is reduced, resulting in less or no tear formation.

The end face of the parallel joint corresponds to the side of the parallel joint formed by the end faces of the foils, i.e., the narrow side of the foils, while the foils lie flat against one another, i.e., with their top and bottom sides.

There are particular advantages if the parallel joint of metallic foils is arranged so that they overlap with an electrical conductor, in particular a collector, and the electrical conductor is welded to the metallic foils by the laser beam being directed onto the end face of the metallic foils in the region of the electrical conductor. In particular, the electrical conductor can be welded to the parallel joint without the need to perform the welding through the foil stack or the electrical conductor. Because the laser beam is directed onto an edge region of the parallel joint, sufficient process energy is input to weld the lower layers of the parallel joint, which are adjacent to the electrical conductor, to the electrical conductor.

It has been found to be particularly favorable if the laser beam is directed onto the end face of the parallel joint at an angle α in the range of 0 a 70° with respect to the normal of the end face. In particular, if the laser beam is directed obliquely onto the end face, particularly good welding can take place with an electrical conductor on which the parallel joint is arranged.

The method can be carried out using a laser beam source suitable for welding copper and aluminum. Such a laser beam source is particularly suitable for welding electrodes and/or current conductors of electrode foils to an electrical conductor.

The laser beam can preferably have a wavelength in the range of 450-1100 nm. Various different materials can be welded with a laser beam having such a wavelength. In particular, copper or aluminum can be welded.

The laser beam source can have an average power in the range of 300-5000 W.

Furthermore, the laser beam source can be operated in continuous wave mode or in pulsed mode or in modulated mode. The operating mode can be selected depending on the components to be welded. A modulated operating mode in this case is to be understood as meaning welding with temporal or spatial modulation. Spatial modulation describes a movement of the laser beam on the surface of the material to be welded, for example in the form of wobble welding. A temporal modulation can be characterized by the fact that the power of the laser has a sinusoidal profile, which has an advantageous effect on the movement of the melt pool.

In order to not only spot weld the foils, it is advantageous if the laser beam is moved along the end face during the welding process. The laser beam can be moved in different directions in order to achieve the best possible connection between the foils.

For example, the laser beam can be moved in a straight line at least in portions over the end face. However, it is also conceivable that the laser beam is moved at least in portions in an oscillating manner over the end face. As a result, a sinusoidal or meandering welded seam can be produced, for example. A circular shape is also possible. It is also conceivable to use the laser beam to create a stitch seam. In principle, it is conceivable that the laser beam is moved over the end face in such a way that the welded seam assumes any given geometry, in particular a prespecified one.

In order to prevent air pockets between the foils and/or the electrical conductor, which would adversely affect the quality of the welded seam, provision can be made for the parallel joint of metallic foils to be clamped, optionally together with the electrical conductor, during welding.

The clamping force for clamping the parallel joint can be adjusted. In particular, the clamping force can be adjusted as a function of the thickness of the parallel joint or of the number of foils.

In order to keep the thermal stress on the parallel joint during welding as low as possible, provision can be made for process heat to be dissipated during welding. Process heat can be dissipated by making the holder used to clamp the parallel joint during welding from materials having particularly good thermal conductivity—for example, copper. Even more cooling can be achieved if the holder/clamping device is actively cooled. Alternatively or additionally, the parallel joint can be actively cooled during the welding process.

The method according to the invention can be used in particular for joining current conductors of electrode sheets, in particular anode sheets or cathode sheets. In particular, the method according to the invention can be used in the production of Li-ion batteries, with the current conductors of anode sheets or of cathode sheets being connected to corresponding electrical conductors, in particular collectors, by means of laser welding.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a side view of a parallel joint made of current conductors of electrode sheets that are welded to a collector; and

FIG. 2 shows a view of the end face of the parallel joint.

### DETAILED DESCRIPTION OF PREFERRED EMBODIMENTS

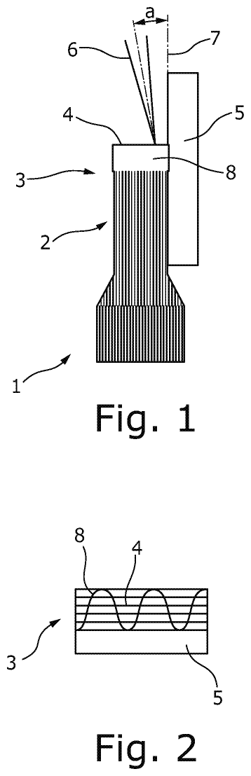

FIG. 1 shows a stack of foils 1 formed as electrode sheets, in particular anode sheets or cathode sheets. Current conductors 2 are arranged on the foils 1. The foils 1 and current conductors 2 are arranged and/or stacked on top of each other over a wide area, and thus form a parallel joint 3. The current conductors 2 are also to be considered as foils. The parallel joint 3 has an end face 4 which is formed by the end faces of the stacked foils 1 and/or current conductors 2. The parallel joint 3 contacts an electrical conductor 5 formed as a collector. The electrical conductor is made of copper or aluminum and is thicker than a single foil 1 and/or a single current conductor 2.

The foils 1 and/or current conductors 2 and the electrical conductor 3 can be made of aluminum or copper.

A laser beam 6 is directed onto the end face 4. In particular, the laser beam 6 is directed onto the end face 4 at an angle α with respect to the normal 7 of the end face 4. The laser beam 6 is moved along the end face 4 and/or two-dimensionally over the end face 4 while maintaining the angle α, such that a weld seam 8 is produced.

It can be seen that the welded seam 8 extends into the electrical conductor 5 in an edge region of the parallel joint 2, in particular in the edge region which adjoins the electrical conductor 5, such that the parallel joint 3 is welded to the electrical conductor 5 as a result. The foils 1 and/or their current conductors 2 are mechanically and electrically conductively connected at the end faces thereof by the weld seam 8.

FIG. 2 shows a top view of the arrangement according to FIG. 1. It can be seen here that the weld seam 8 runs sinusoidally over the end face 4. The weld seam 8 was produced by moving the laser beam 6 over the end face 4 with different directional components. In the regions in which the weld seam 8 touches the electrical conductor 5, said electrical conductor is connected to the parallel joint 3.

Although only a few embodiments of the present invention have been shown and described, it is to be understood that many changes and modifications may be made thereunto without departing from the spirit and scope of the invention.

What is claimed is:

1. A method for welding metallic foils, having the method steps of:
a. forming a parallel joint with a plurality of metallic foils to be joined, by arranging the foils in such a way that the foils contact each other over a wide area, and
b. welding the metallic foils together by directing a laser beam onto an end face of the parallel joint of the foils, such that a weld seam joining the foils is formed.

2. The method according to claim 1, wherein the parallel joint of metallic foils is arranged to overlap with an electrical conductor, and the electrical conductor is welded to the metallic foils by the laser beam being directed onto the end face of the metallic foils in the region of the electrical conductor.

3. The method according to claim 1, wherein the laser beam is directed onto the end face of the parallel joint at an angle α in the range of 0 a 70° with respect to the normal of the end face.

4. The method according to claim 1, wherein the method is carried out using a laser beam source suitable for welding copper and aluminum.

5. The method according to claim 1, wherein the laser beam has a wavelength in a range of 450-1100 nm.

6. The method according to claim 1, wherein a laser beam source is used which has an average power in a range of 300-5000 W.

7. The method according to claim 6, wherein the laser beam source is operated in continuous wave mode or in pulsed mode or in modulated mode.

8. The method according to claim 1, wherein the laser beam is moved along the end face during the welding process.

9. The method according to claim 1, wherein the laser beam is moved at least in portions in a straight line over the end face.

10. The method according to claim 1, wherein the laser beam is moved at least in portions in an oscillating manner over the end face.

11. The method according to claim 1, wherein a stitch seam is produced by the laser beam.

12. The method according to claim 1, wherein the parallel joint made of metallic foils is clamped during welding.

13. The method according to claim 12, wherein the clamping force for clamping the parallel joint is adjusted as a function of a thickness of the parallel joint or of a number of foils.

14. The method according to claim 1, wherein process heat is dissipated during the step of welding.

15. The method according to claim 1, wherein the metallic foils are current conductors of electrode sheets, in particular of anode sheets or cathode sheets.

16. The method according to claim 2, wherein the parallel joint made of metallic foils is clamped during welding together with the electrical conductor.
